(19) United States
(12) Patent Application Publication
(10) Pub. No.: US 2011/0154111 A1
(43) Pub. Date: Jun. 23, 2011

(54) Memory Based Hardware Breakpoints

(75) Inventors: Arnold Beilmann, Heidelberg (DE); Katharina Probst, St. Leon-Rot (DE); Eduard Diner, Leiman (DE); Caecilie Hampel, Karlsruhe (DE); Eric Kass, Mannheim (DE); Olaf Rutz, Sandhausen (DE); Henning Sackewitz, Heidelberg (DE); Andreas Steiner, Ludwigshafen (DE)

(73) Assignee: International Business Machines Corporation, Armonk, NY (US)

(21) Appl. No.: 12/962,207

(22) Filed: Dec. 7, 2010

(30) Foreign Application Priority Data
Dec. 23, 2009 (EP) 09180595.2

(51) Int. Cl. G06F 11/07

(52) U.S. Cl. 714/34; 714/E11.029

(57) ABSTRACT

A mechanism is provided for managing hardware breakpoints within a computing environment comprising a processor and a memory unit with addressable words being extended using metadata. A setting or deleting of a breakpoint is issued at a specific address within the memory unit by forwarding from the processor to the memory unit the metadata. An addressable word is requested from the memory unit by forwarding a physical address of the addressable word via an address bus from the processor to the memory unit. The physical address is decoded to find the addressable word within the memory unit. Responsive to the metadata associated with the addressable word being available, the metadata is provided to the processor. A checking is made as to whether a breakpoint is set in the metadata. Responsive to the breakpoint being found in the metadata, an interrupt is triggered thereby executing the breakpoint.

### BACKGROUND

This invention relates to managing hardware breakpoints for debugging and problem determination in programs related to memory content within a computer environment. In particularly the present invention relates to managing breakpoints within computer environment comprising a processor and a memory unit.

Even with intensive test procedures, software contains functional bugs and potential security leaks. One typical class of errors is the incorrect use or change of memory content. An incorrect use or change of memory content may happen due to programming errors (e.g. dereferencing wrong pointers) or the exploitation of security holes (e.g. enforce buffer overflows). An important case of such errors are large productive customer systems, where the error occurs infrequently and not reproducible. Until now those situations lead to very long problem determination processes. A common method to diagnose such errors is the use of hardware breakpoints. Hardware breakpoints provide the possibility in hardware to react on memory access or change. The existing implementations of hardware breakpoints are based on special purpose registers in CPUs (central processing units). Due to this implementation, the number of breakpoints is limited. Additionally, in multiprocessor systems identifying errors is hard in shared memory segments since the hardware breakpoints are bound to a single CPU.

Currently, hardware breakpoints are implemented with special purpose registers. The fundamental mechanism is always the same and differs only in some details. FIG. 1 shows a schema describing common mechanism according to prior art. During program execution there are several instructions, which need to access the physical memory 102. In order to get the data from the physical memory 102, a virtual address 104 needs to be used (ADDR). This virtual address 104 is translated by a memory management unit (MMU) 106 within the processor 108 to get a physical address 110 identifying the specific memory word 112 of the physical memory 102 to address. This physical address 110 is then used to get the data 114 from the specific memory word 112. Once the data 114 is passed to the processor 108, the data 114 can be manipulated in functional units (FU) 116, which might be an integer arithmetic unit or something else. A hardware breakpoint is implemented by special purpose registers 118. Sometimes they are also called control registers (CR) 118. The memory management unit 106 compares the virtual address 104 to the content of the control register 118. In case the virtual address 104 matches the conditions described by the control register 118 then an event 120 is generated. This event 120 is in most cases a hardware interrupt. By defining an adequate interrupt routine, the operating system or analysis software like a debugger can react on this event accordingly.

Thus, some common processor architectures use prior art breakpoints. The Power Processor of Power System contains several Local Debug Registers. Eight of them do address comparison as described above. Four are used for instruction address compare (IAC1-IAC2) and four for data address compare (DAC1R, DAC1W, DAC2R, DAC2W). Two additional registers can be used for data value compare.

System z product is implementing hardware breakpoints with 2 control registers CR10 and CR11. They can be used to define single addresses or address ranges where a breakpoint can be set on a memory address. The infrastructure to manage those breakpoints is based on SLIP (Serviceability Level Indication Processing). Breakpoints can be set on storage access (SA) or instruction fetch (IF).

Also the Intel x86 architecture is providing hardware breakpoints through a set of debug registers DR0-DR6. U.S. Pat. No. 7,047,520 describes a method that allows a general set of watch-points to be defined for a computer system, a watch-point being a memory address that triggers an interrupt for debugging or tracing purposes. This is accomplished by modifying the system page table for the memory page containing a watch-point, such that a page fault interrupt is triggered, whenever said memory page is accessed. The paging mechanism of the computer system is then adapted, so that responsive to a page fault interrupt, a determination is made as to whether such interrupt has resulted from an access to the watch-point, and if so, control is passed to a watch-point handler. U.S. Pat. No. 7,447,942 describes a technique to implement software debugging capability using breakpoints by creating breakpoints, storing them in a watch-list, and paging out a virtual address VA to physical address PA page entry in a translation look-aside buffer TLB. When software under test is run at full speed, memory is accessed via the TLB VA to PA page translation. When a translation is missing, an exception is generated. Handling the exception includes determining if the page missing from the TLB matches a breakpoint address in the watch-list.

One of the major drawbacks of the existing solutions is the use of special purpose registers to implement hardware breakpoints. The first deficiency is the limited number of breakpoints which can be set due to this implementation. This limitation can become a real issue where multiple distinct memory areas need to be monitored. Another problem arises from the fact that in implementations according to prior art the breakpoints are set on virtual addresses. Shared memory segments can be attached to a running program at different virtual addresses over time. And a breakpoint on a virtual address may be invalid after a segment is re-attached to another virtual address.

Special purpose registers are bound to a CPU. In contrast, a shared memory segment may be attached to multiple processes. But in the case of a multi-processor system, after one process has set a hardware breakpoint to a memory area in the shared memory segment, another process could overwrite this memory area. This would imply that the breakpoint is not hit when this second process runs on a different CPU unless handled by the operating system with significant effort.

### BRIEF SUMMARY

In one illustrative embodiment, a method, in a data processing system, is provided for managing hardware breakpoints within a computing environment comprising a processor and a memory unit with addressable words being extended using metadata. The illustrative embodiment issues a setting or deleting of a breakpoint at a specific address within the memory unit by forwarding from the processor to the memory unit the metadata. The illustrative embodiment requests an addressable word from the memory unit by forwarding a physical address of the addressable word via an address bus from the processor to the memory unit. The illustrative embodiment decodes the physical address to find the addressable word within the memory unit. Responsive to the metadata associated with the addressable word being available, the illustrative embodiment provides to the processor the metadata. The illustrative embodiment checks whether a breakpoint is set in the metadata. Responsive to the breakpoint being found in the metadata, the illustrative embodiment triggers an interrupt thereby executing the breakpoint.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a data processing system is provided. The data processing system may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The subject matter which is regarded as the illustrative embodiments is particularly pointed out and distinctly claimed in the claims at the conclusion of the specification. The foregoing and other objects, features, and advantages of the illustrative embodiments are apparent from the following detailed description taken in conjunction with the accompanying drawings in which:

FIG. 1 illustrates a schema of a mechanism according to prior art;

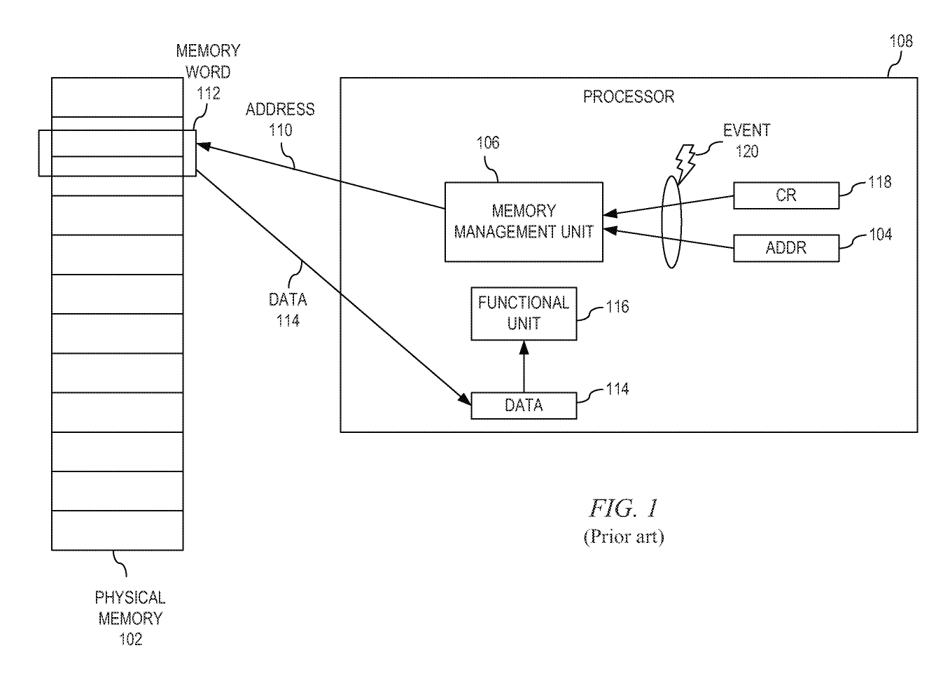

FIG. 2 illustrates a schema of a mechanism in accordance with an illustrative embodiment;

FIG. 3 illustrates one example of a computer system in accordance with an illustrative embodiment;

FIG. 4 illustrates a flowchart of the method in a read phase in accordance with an illustrative embodiment;

FIG. 5 illustrates a flowchart of the method in a write phase in accordance with an illustrative embodiment;

FIG. 6 illustrates one example of a computer system in accordance with an illustrative embodiment;

FIG. 7 illustrates one example of a computer system in accordance with an illustrative embodiment.

The detailed description explains the preferred embodiments of the illustrative embodiments, together with advantages and features, by way of example with reference to the drawings.

### DETAILED DESCRIPTION

The idea of the illustrative embodiments is to provide an alternative implementation for Hardware Breakpoints by using metadata for storing the breakpoints in the physical memory—as additional bits. The number of addressable words associated with a single entry of metadata may differ between specific implementations. An advantage is to choose the size a CPU can fetch with a single load operation, e.g. 8 bytes. The selection of the size corresponds to the granularity the system can detect a memory breakpoint. Whenever data is loaded into the CPU the associated metadata is loaded as well. The same is true for store operations. If the loaded data is passed to a functional unit, like the integer arithmetic part, and the metadata is set, an event will be triggered. While not absolutely necessary, the event may be implemented as an interrupt. In this case, the interrupt handling routine will contain all functionality to handle the hardware breakpoint.

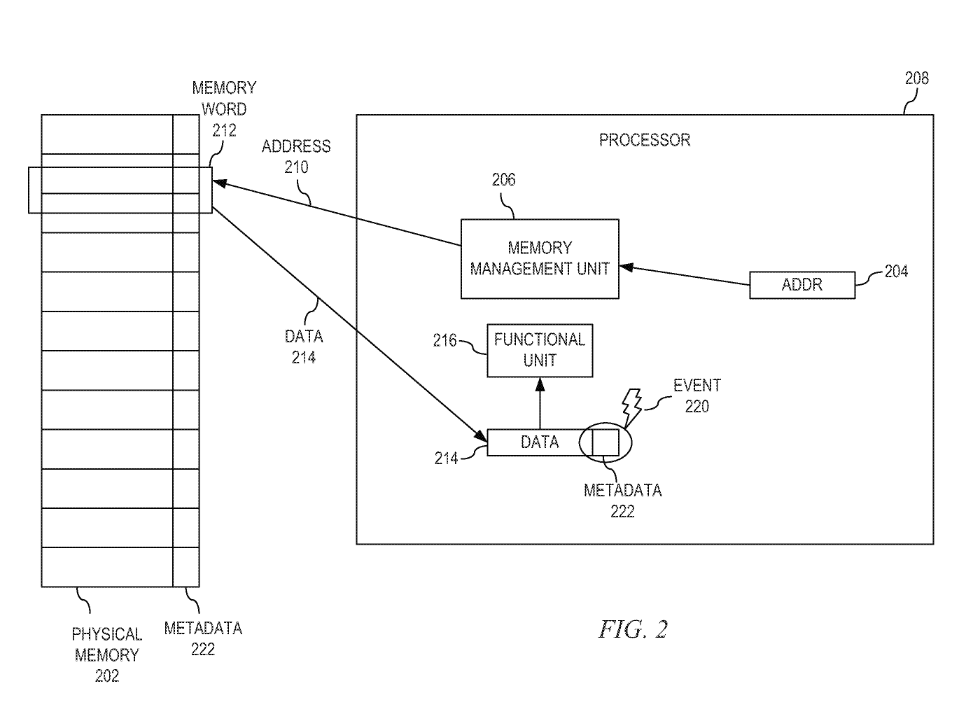

Turning now to the drawings in greater detail, it will be seen that in FIG. 2 is described a schema of the fundamental mechanisms in accordance with an illustrative embodiment. During program execution there are several instructions which need to access the physical memory 202. In order to get the data 214 from the physical memory 202, a virtual address 204 needs to be used (ADDR). This virtual address 204 is translated by a memory management unit (MMU) 206 to get a physical address 210 used to get the data 214 from the physical memory 202. In the implementation as shown on FIG. 2, the data 214 is passed along with the metadata 222 to the processor 208. The data 214 can be manipulated in functional units (FU) 216 which might be an integer arithmetic unit or something else. A hardware breakpoint is implemented by the metadata 222. If data is passed to a functional unit 216 and the metadata 222 indicates a hardware breakpoint then an event 220 is generated. This event 220 can be a hardware interrupt. By defining an adequate interrupt routine, the operating system or analysis software like a debugger can react on this event 220.

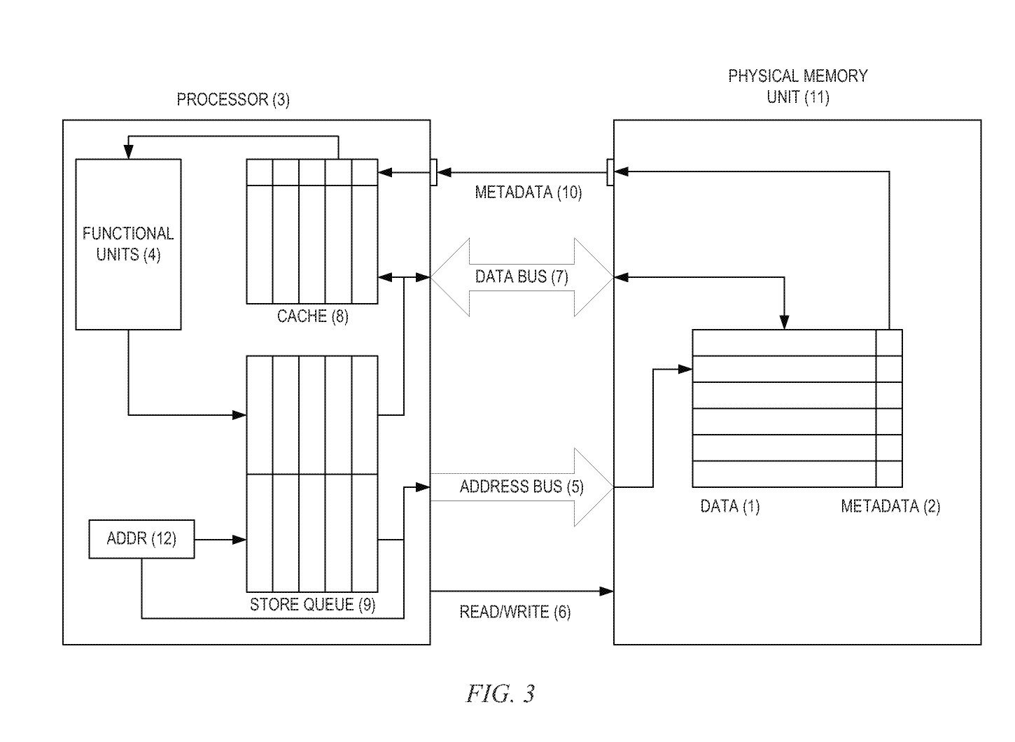

FIG. 3 shows an implementation of a computer system in accordance with an illustrative embodiment. The computer system comprises a processor 3 and a physical memory unit 11 interconnected via an address bus 5, an electrical line 6, which may also be referred to as read/write indicator line 6, associated to the address bus 5, a data bus 7 and a supplementary electrical line 10, which may also be referred to as the metadata bus 10, for the forwarding of the metadata. The physical memory unit 11 is extended in hardware to provide additional metadata 2 associated with certain entities (data word) of the data 1 in the physical memory unit 11. Different specific implementations can be conceived within the scope of the illustrative embodiments like additional bits in the memory chip itself (similar like parity bits), additional logic etc. The important feature is that metadata used for setting breakpoint are available when accessing a physical memory entity to which the metadata is associated.

The processor 3 shown on FIG. 3 consists of one CPU of a computer system while only the most relevant parts for the illustrative embodiments are schematically pictured. The processor 3 contains several functional units 4 (e.g. Add). For the illustrative embodiments, at some point data is requested to be read or written of the physical memory unit 11 by these functional units 4. In the simplest case, the address 12 of the physical memory unit 11 to be accessed is forwarded via the address bus 5 to the physical memory unit 11 together with an indication of the access mode i.e. read or write access, such indication being forwarded via a specifically dedicated additional electrical line 6. Depending on the access mode, either the data 1 from the physical memory unit 11 is put to the data bus 7 and used by the processor 3 or the data available on the data bus 7 is copied into the physical memory unit 11 at the addressed word. More complex CPU's may contain as well some caches 8 and buffers for the data to be stored 9 (store queues). The metadata 2 itself associated to the addressed data word 1 is also available to the processor 3 but on a separate electrical lines 10 (usually only 1 but not necessarily).

The functionality of the illustrative embodiments needs to be divided into 3 activities:
The read phase;
The write phase; and
Managing the Breakpoints.

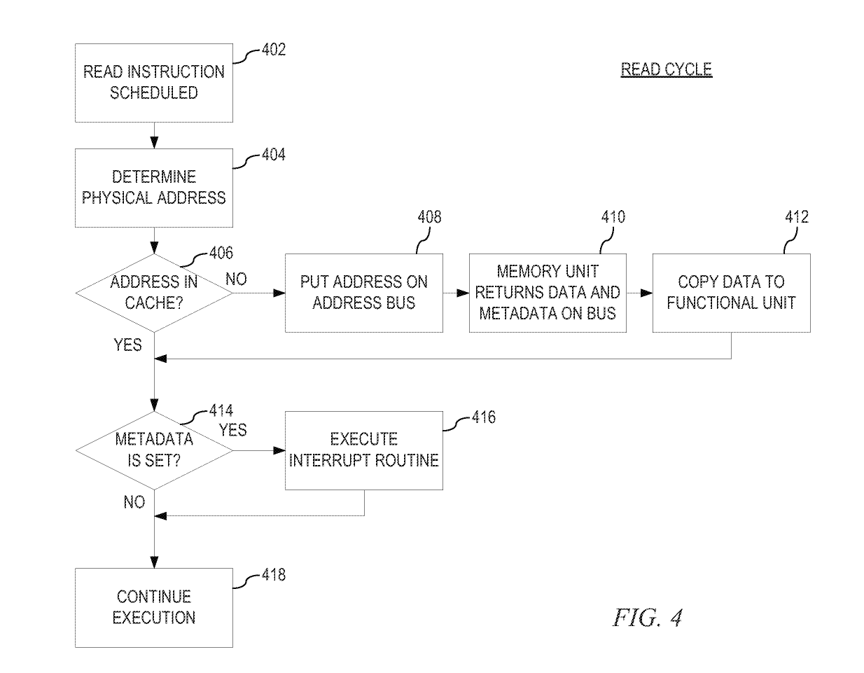

FIG. 4 shows a flowchart describing the read phase in accordance with an illustrative embodiment. An instruction is scheduled in the processor 3 to be executed in the functional units 4 and requires data 1 from the physical memory unit 11 (step 402). In the next step, the physical address is determined (step 404). This may require on some systems a virtual address translation. Present description is limited to the use of physical addresses even if virtual address handling can be somehow required. If at step 406 the address is not found in the cache in the case a cache is used, then the found physical address is put to the address bus 5 and the read/write indicator line 6 is set to read (step 408). The physical memory unit 11 decodes the address 12 on the address bus and puts the associated data entry 1 on the data bus 7 (step 410). The associated metadata 2 is put to the metadata bus 10 for forwarding metadata between the memory unit 11 and the processor 3 (also step 410). The processor 3 copies the data from the data bus 7 to the cache 8 including the metadata available on the specific line 10. If the processor 3 detects the requested memory in the cache 8, the data is then copied from the cache 8 to the functional units 4 (step 412). From step 412 or if at step 406 the address is found in the cache, then a determination is made as to whether the metadata in the cache is set, i.e. a breakpoint is set for this addressed data word (step 414). If at step 414 the metadata in the cache is set, an interrupt is then triggered (step 416) and the breakpoint handling can be executed (step 418). If at step 416 the metadata in the cache is not set, normal processing can continue step (418). If the CPU executes instructions speculatively the breakpoint interrupt would be deferred until the instruction issued the read request is committed.

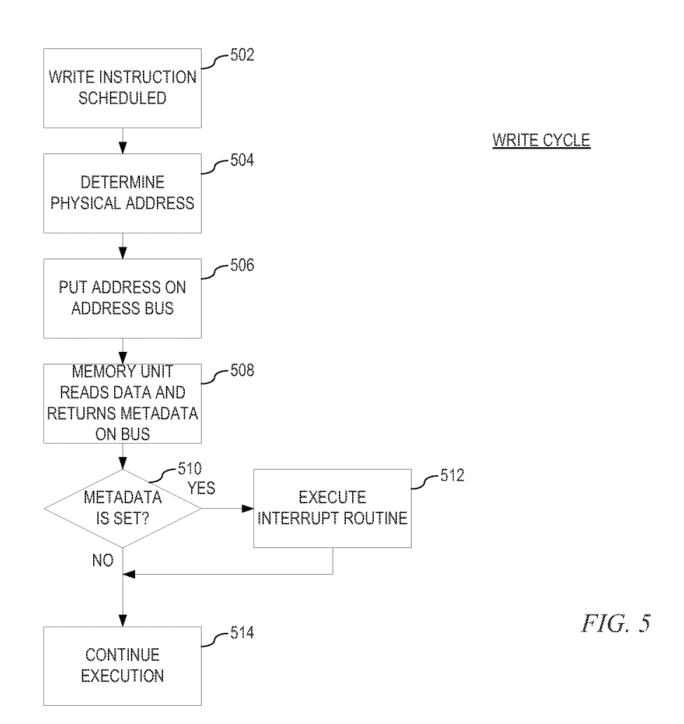

FIG. 5 shows a flowchart describing the write phase in accordance with an illustrative embodiment. An Instruction is scheduled in the processor 3 to be executed in the functional units 4 and requires data to be written to the physical memory unit 11 (step 502). In the next step, the physical address is determined which may require on some systems a virtual address translation (step 504). The physical address is put to the address bus 5 and the read/write indicator line 6 is set to write (step 506). The physical memory unit 11 decodes the address on the address bus 5 and copies the data from the data bus 7 into the physical memory unit 11 at the addressed place (step 508). At the same time the associated metadata 2 related to the decoded address is put to the corresponding bus 10 (also step 508). If the processor 3 detects the metadata 2 on bus 10 as set, i.e. a breakpoint for this data word is set step (510). If at step 510 the metadata as set, then an interrupt is triggered (step 512) and the breakpoint handling can be executed (step 514). If at step 510 the metadata is not set, normal processing can continue (step 514).

If the CPU is using store queues 9 (write-back-queues), then the interrupt occurs at the time when the memory is actually written. There may be a delay between the instruction that issued the write and the interrupt. The processor 3 would handle this delayed interrupt similarly to the way the processor 3 handles a delayed page fault. Namely, the CPU must be able to identify the instruction causing the write.

Managing the breakpoints: In the read and write phase the metadata used for setting a breakpoint is passed along with the data between processor 3 and physical memory unit 11. In the managing phase, this metadata needs to be modified. A specific implementation for that metadata is not required for implementing the illustrative embodiments. Just, a possibility must be provided to read and write the metadata associated to a specific memory address or data word. They are multiple options for that.

For example, the latter could be achieved by a dedicated assembler instruction. This could be a variant from the decorated store available in PowerPC and allows more complex operations on memory without the CPU. Such functionality must be provided by the physical memory. Another example could be the use of internal control registers in the CPU where certain bits of the control registers are mapped to electrical lines which are also connected to the memory unit. In such a case, one bit could contain a flag that the metadata should be written and another bit the metadata itself. The metadata could be updated during a write cycle by just maintaining some bits in a control register.

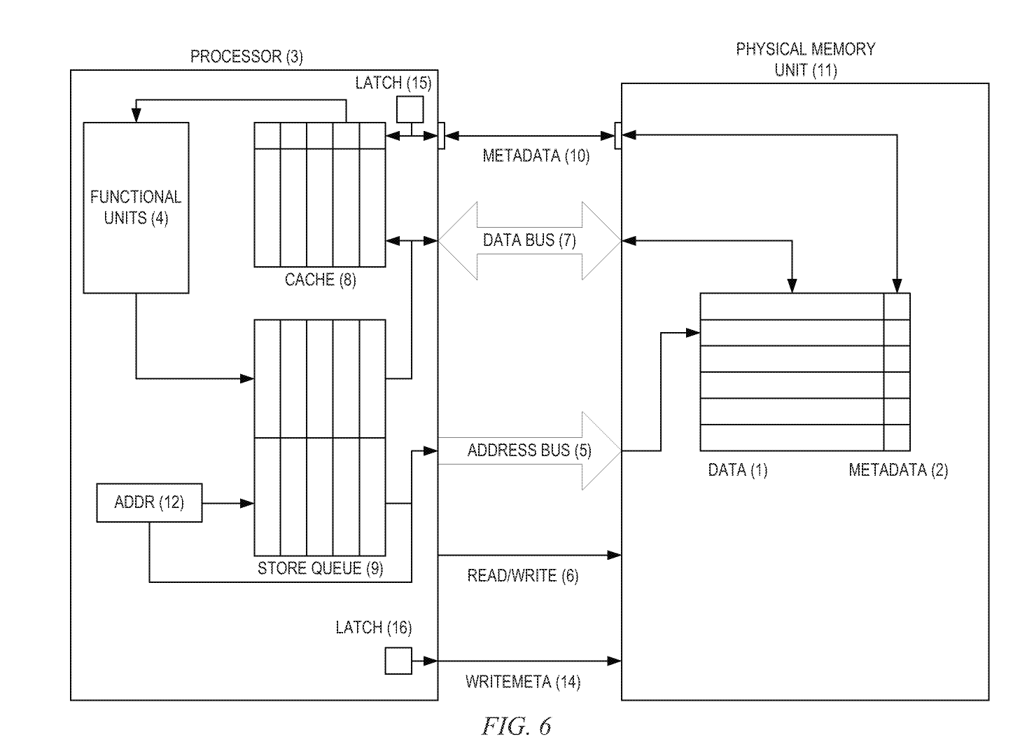

In the following are described with more details some implementations of a management of breakpoints. For example, the issuing of a setting and deleting of breakpoints is achieved with a specific assembler instruction named possibly ‘setmbp’ (set memory break point) and ‘delmbp’ (delete memory breakpoint). The assembly for setting a memory break point could look like the following: setmbp <address>. Similarly, the assembly for deleting the memory breakpoint could be: delmbp <address>. FIG. 6 shows a computer system in accordance with an illustrative embodiment similar to FIG. 4 with some extension allowing the use of special instructions for the management of breakpoints. When a ‘setmbp’ or ‘delmbp’ instruction is issued then the address is put to the address bus 5. A latch 16, which is a simple addressable bit for buffering in the CPU, is set to ‘1’. Depending on the instruction, a second latch 15 is set to ‘1’ (setmbp) or ‘0’ (delmbp). The content of the latches 15, 16 is visible on the corresponding electrical lines 10 and 14. If the physical memory unit 11 detects the WriteMeta line 14 being set, the physical, memory unit 11 stores the metadata from the corresponding bus 10 in the metadata bits 2 of the physical memory unit 11. In the same manner that a multi processor system invalidates caches during write, the set/delete breakpoint operation would cause caches to be invalidated as well.

Another alternative for implementing the manageability of the metadata without an additional assembly instruction is based on the use of 2 bits in a control register of the CPU. The first bit indicates a ‘WriteMeta’ and the second bit of the control register the metadata itself. The assembly language may look like the following (assuming bit 0 and 1 are used in the control register, and the breakpoint should be set):
ori <control register>,0×03 (logical OR immediate)
st <address>,<data> (store <data> at <address>)

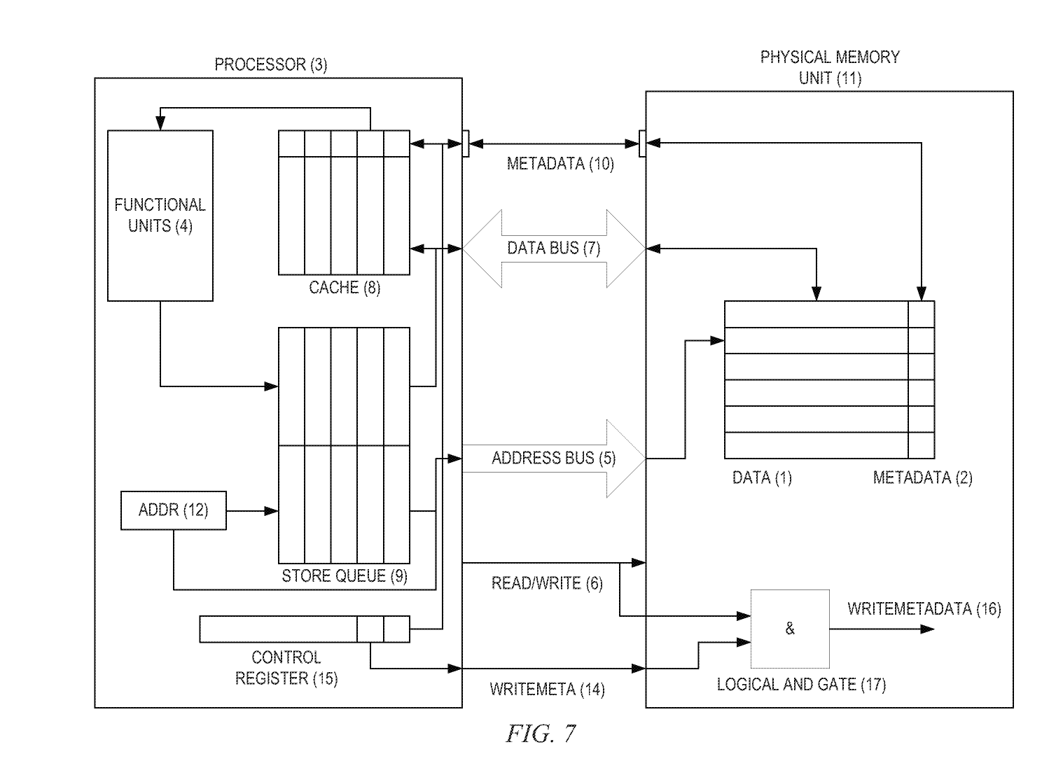

FIG. 7 shows in a simplified way a computer system in accordance with an illustrative embodiment similar to FIG. 4 with now a control register for managing the metadata. Assuming that the store operation does not use a store queue 9, in case a store queue 9 would be required, the internal infrastructure in the CPU would need to take care of this, e.g. by keeping the metadata bit in the store queue as previously described for the cache.

The procedure would be the following to set or unset (delete) the memory breakpoint. First the bit indicating a ‘write’ for the metadata is set in the control register 15 including the metadata itself. This could be done by logical operations on the control register like in the sample code above. In the next write cycle of the processor 3, the following events will occur. For the write operation the ‘write’ bit is set on indicator line 6. The data is available on the data bus 7 and the address on the address bus 5. Also the WriteMeta line 14 for writing the metadata 2 are set as well as the metadata 2 on the metadata bus 10 due to the bits set in the control register 15. The data 1 is written at the addressed location of the physical memory unit 11. A logical “AND” gate 17 is combining the ‘Write’ and ‘WriteMeta’ signals and sets the physical memory unit 11 into a state 16 to write the metadata from the metadata bus 10 into the areas containing the metadata 2 itself. This specific state 16 of the physical memory unit 11 would also prevent the signaling of the memory break point, as state 16 would usually occur on a write cycle. An advantage is to use specific assembly instruction for managing the breakpoints as described above at FIG. 6 to better cope with the larger complexity of this last implementation.

Thus, the illustrative embodiments keeping hardware breakpoints directly in memory which is the only part in the system shared by all components and is unique. Therefore, no synchronization of breakpoints between multiple parts in the system is necessary and the setting and using of a memory breakpoint is simple. Also, the illustrative embodiments provide additional advantages, like an almost unlimited number of breakpoints, finer granularity and very low impact on a running system. Therefore, the presently proposed mechanism can be used also for problem determination under high load.

Modern CPUs contain additional units like caches, prefetch units, etc, Data moved through those components must preserve the associated metadata. This may require a slight design change of the affected components. Additional CPU instructions are required to access, change and check the metadata. A dedicated Interrupt needs to be defined. The size of a memory area associated with a single entry in the metadata may differ between specific implementations. An advantage is to use the size a CPU can fetch with a singe load operation, e.g. 8 bytes. The interrupt for an event might occur on every CPU, so the concrete implementation of hardware breakpoints might include an interrupt handler in the OS Kernel and consumers for those events may need to register in the Kernel/Hypervisor. The metadata could be for example stored in unused bits of an ECC checksum in memory, like the server ‘IBM i’ is doing with the tag bit. Another possibility could be the use of additional memory chips.

They are multiple use cases which can benefit from such a system according to the the illustrative embodiments. The following are three detailed representative cases but other cases could be chosen within the scope of the illustrative embodiments.

In some scenarios, a programming error may lead to a memory overwrite in a shared memory segment. Such an error may occur very infrequently. On a productive system under high load this may have a major impact. Such an error when appearing may cause a complete application failure and a complete restart of the system must be performed, a very unsatisfactory situation. The memory overwrite does not happen always at a specific address. Instead, the memory overwrite is a non reproducible pattern across a large chunk of memory. Therefore, methods according to prior art for hardware breakpoints with limited number of registers are not applicable in this case. This example describes very well a big class issues which could advantageously be addressed by an implementation in accordance with an illustrative embodiment providing a much better turnaround and resolution time of critical software errors on such large system. In particular, a developer having to deal with such an issue can now solve the issue by setting hardware breakpoints using a debugger supporting such computer system environment (infrastructure). In case the number of breakpoints is huge and the pattern of the memory overwriting is known then one possibility is to set the breakpoint programmatically i.e. at specific locations. For example, if the error occurs always when the administration area of an internal structure is overwritten then the breakpoint shall be set for all address locations of the memory where the program creates those internal structures.

As described above, programming errors lead to memory overwrites. In case the memory area is located in the heap of a process, and the faulty program is overwriting an allocated memory area, this action does usually not end immediately in a failing program. Instead, only internal structures managing the heap are overwritten. The error might get visible much later when the program is trying to request or free another chunk of memory from the heap. That means there might be a huge time difference between the error itself and the detection of the error, so that root cause analysis is almost impossible. Up to now, such issues are solved by adding checks for the consistency of the heap so that the time interval between the error and the detection is smaller. But such reduction of the time interval cannot be performed sufficiently and error analysis remain very difficult. The use of an infrastructure in accordance with an illustrative embodiment can very effectively help to solve such a problem. The structure of a heap for c-runtime heaps is a linked list of structures. Parts of those structures contain the user data. A call to the memory allocation routine (malloc( )) by a program would return an address to the start of such a part. Administrative regions surround the user data. The administrative area is used by the runtime to manage the storage as lists of links.

The use of an infrastructure in accordance with an illustrative embodiment for a safe heap could be as follow. In one embodiment, every routine in the operating system runtime dedicated to the heap management would disable the interrupt routine monitoring for debug exceptions while administrating the memory blocks. The runtime would also set hardware breakpoints covering the administrative region before returning a region to the program. Once leaving those routines, the interrupt handler will be activated again. If a command of a program were to write over the administrative data, an exception would be generated and the interrupt routine would get activated; thus the program causing the overwrite could be identified immediately. In a second embodiment, instead of disabling and enabling an interrupt handler, the breakpoints in specific administrative memory regions would be disabled by the runtime for the duration of administrative processing.

An analogous implementation according to the illustrative embodiments for program runtime stacks solves the buffer overflow problem. Today a lot of security breaches in web servers is caused by external users trying to inject buffer overflows by providing wrong input data. The same mechanisms as described in the previous example can be used to protect heap and stack buffers from rogue overwrites. When constructing the instruction sequence to instantiate a new stack frame in preparation for calling a sub-function, the compiler would add a guard-byte (an additional byte of memory on the stack-frame assigned to a hardware-breakpoint) between the current stack frame and the new one. Any misbehaved software that overwrites designated stack storage would cause an exception when the guard-byte was inadvertently written. The instruction sequence to collapse the stack frame, for after the sub-function completes, would remove the guard-byte (by disabling the hardware breakpoint on that byte). In another embodiment, the compiler could also guard variables designated constant by enabling hardware-breakpoints on regions of memory in the stack (or heap or static storage) associated with constant variables. For changing from constant to non-constant (e.g. by way of a programming construct called a cast), the compiler would add instructions to disable hardware-breakpoints on the specific region of memory for the duration that the variable was to be treated non-constant.

The illustrative embodiments show multiple advantages over prior arts. Implementing the hardware breakpoints in physical memory allows extending the amount of hardware breakpoints tremendously. At the same time, the illustrative embodiments do not impact performance of actual workload of systems even for long term analysis. Assigning the breakpoint to data instead of CPU makes it possible to easily analyze memory overwrites on shared memory of multi-core processors. Furthermore, using a flag on physical memory avoids the breakpoint to become invalid what is not true for existing solutions using virtual addressing. The number of breakpoints is only limited by the size of the physical memory and the granularity. The breakpoints are independent from a specific CPU instance in a computer system, therefore perfectly usable for shared memory areas in multi processor systems. No performance impact can be noticed when accessing memory without breakpoint set while for memory with breakpoint the access is only dependent on the called interrupt routine. An implementation in accordance with an illustrative embodiment can be supported in long term and shows low performance impact debugging. Furthermore, the illustrative embodiments are independent from virtual addressing e.g. Shared memory segments can be attached during lifetime at different virtual addresses

The capabilities of the illustrative embodiments can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method for managing hardware breakpoints within a computing environment comprising a processor and a memory unit with addressable words being extended using metadata, the method comprises following steps:
issuing, by the processor, a setting or deleting of a breakpoint at a specific address within the memory unit by forwarding from the processor to the memory unit the metadata;
requesting, by the processor, an addressable word from the memory unit by forwarding a physical address of the addressable word via an address bus from the processor to the memory unit;
decoding, by the memory unit, the physical address to find the addressable word within the memory unit;
responsive to the metadata associated with the addressable word being available, providing, by the memory unit, to the processor the metadata;
checking, by the processor, whether a breakpoint is set in the metadata; and
responsive to the breakpoint being found in the metadata, triggering, by the processor, an interrupt thereby executing the breakpoint.

2. The method according to claim 1, wherein the metadata within the memory unit associated to the addressable word is forwarded via a specific electrical line between the processor and the memory unit.

3. The method according to claim 1, wherein the breakpoint is managed using dedicated assembler instructions, when issued, setting or deleting the breakpoint at an addressed location within the memory unit.

4. The method according to claim 1, wherein the breakpoint is managed using a control register within the processor such that a bit of the control register, when issued, setting or deleting the breakpoint at an addressed location within the memory unit and wherein the metadata itself being defined as bits of the control register.

5. A computer system comprising:
a processor; and
a memory unit with addressable words being extended using metadata, wherein:
the processor and the memory unit being interconnected via an address bus to forward from the processor to the memory unit addresses of the addressable words within the memory unit to be addressed,
an electrical line associated to the address bus for indicating to the memory unit the access mode between read and write,
a data bus for exchanging the the addressable words with the processor,
when issuing a setting or deleting of a breakpoint at a specific address within the memory unit, the processor is forwarding to the memory unit the metadata, and
when receiving metadata, the processor is checking whether the breakpoint is set at the metadata to trigger an interrupt thereby executing the breakpoint.

6. The computer system according to claim 5, wherein the processor and the memory unit are interconnected via a specific electrical line for forwarding the metadata defining the breakpoint associated to the addressable word.

7. The computer system according to claim 5, wherein the processor comprises specific latches for managing the issuing of the breakpoint at an addressed location within the memory unit.

8. The computer system according to claim 5, wherein the processor comprises a control register for managing the breakpoint such that a bit of the control register, when issued, sets or deletes the breakpoint at an addressed location within the memory unit and herein the metadata itself being defined as bits of the control register forwarded between the processor and the memory unit.

9. A computer program product for managing hardware breakpoints, the computer program product comprising a computer usable medium having computer usable program code embodied therewith, the computer usable program code, when executed by a computer system, causes the computer system to:
issue a setting or deleting of a breakpoint at a specific address within a memory unit by forwarding from a processor to the memory unit the metadata;
request an addressable word from the memory unit by forwarding a physical address of the addressable word via an address bus from the processor to the memory unit;
decoding the physical address to find the addressable word within the memory unit;
responsive to the metadata associated with the addressable word being available, provide to the processor the metadata;
check whether a breakpoint is set in the metadata; and
responsive to the breakpoint being found in the metadata, trigger an interrupt thereby executing the breakpoint.

10. The computer program product according to claim 9, wherein the metadata within the memory unit associated to the addressable word is forwarded via a specific electrical line between the processor and the memory unit.

11. The computer program product according to claim 9, wherein the breakpoint is managed using dedicated assembler instructions, when issued, setting or deleting the breakpoint at an addressed location within the memory unit.

12. The computer program product according to claim 9, wherein the breakpoint is managed using a control register within the processor such that a bit of the control register, when issued, setting or deleting the breakpoint at an addressed location within the memory unit and wherein the metadata itself being defined as bits of the control register.
